(19) United States
(12) Patent Application Publication
(10) Pub. No.: US 2008/0255985 A1
(43) Pub. Date: Oct. 16, 2008

(54) Novel Method for Creating a Mortgage Moratorium

(76) Inventor: Anthony I. Hoffman, Sherman Oaks, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/734,087

(22) Filed: Apr. 11, 2007

(51) Int. Cl. G06Q 40/00

(52) U.S. Cl. 705/38

(57) ABSTRACT

A method for creating a moratorium period for a mortgage, comprising the following the steps: creating an equity loan amount to be loaned based upon the value of a mortgagee's property; determining the monthly payment on the loan; determining a period of months which the mortgagee desires to avoid personally making monthly payments; placing a portion of the loan amount equal to the monthly payments for the desired period of months into a fund; and making the monthly payments for the predetermined period from the fund.

### FIELD OF THE INVENTION

The present invention is directed to the field of mortgage payment systems and methods. In particular, the present invention is directed to a system for monthly mortgage to have a mortgage moratorium.

### BACKGROUND OF THE INVENTION

Within the last fifteen (15) years there have been dozens of new methods for financing home ownership. These include adjustable rate mortgages, graduated payment mortgages, option payments, PRMS and buy down loans. Rerge mortgages have been very popular recently.

There have been a number of patents which have on mortgage related products and services. U.S. Pat. No. 5,966,700 to Gould is directed towards a computer system for managing the allocation of mortgage pool risk between a mortgage originator and a funding institution. The mortgage originator issues a mortgage and the funding institution agrees to assume certain risks such as interest rate and credit risk for the mortgage up to a certain percentage. The mortgage originator and the funding institution enter into a Master Commitment agreement which has an overall credit enhancement value for mortgage funding by the mortgage originator. The system has an input device capable of receiving mortgage data from the mortgage originator. A memory has a database storing the data relating to the mortgage loan, Master Commitment, financial institution and rate and fees. A processor calculates a credit enhancement value as a function of the probability of foreclosure and the severity of loss indicated by mortgage data. An output device produces a delivery commitment in which the mortgage originator assumes obligation for losses up to the credit enhancement value and the funding institution assumes obligation for additional losses.

U.S. Pat. No. 5,991,745 to Kiritz is directed towards a system and process of calculating monetary payments by a lender to a borrower based on the value of an asset using at least one of a plurality of constants stored in look-up tables. The process includes inputting borrower information such as borrower birthdate or age. Property specific information is input, such as appraised property value. Equity share information is also input. With the Equity share information and borrower age, the process looks-up a tenure conversion factor from a look-up table. The loan type is input as one of tenure, line of credit, and modified tenure and appropriate variables are set accordingly. The principal limit factor is read from a look-up table and the original principal limit is calculated to be equal to the principal limit factor multiplied by the appraised property value. Next the net principal limit is calculated as the original principal limit minus costs. The loan is then calculated—if tenure, then the monthly payment equals net principal limit times tenure conversion factor, if line of credit, then the net principal limit equals the line of credit, and if modified tenure, then net line of credit equals net principal limit minus (monthly payment divided by tenure conversion factor), when a monthly payment amount was requested or monthly payment equals (net principal limit minus net line of credit) multiplied by tenure conversion factor when a net line of credit was requested.

U.S. Pat. No. 6,345,262 to Madden is directed towards a system and method for implementing a mortgage plan. Data is input to a computer system regarding the mortgage terms, and the computer system is used to prepare a mortgage document which creates an equity participation mortgage obligation in which the lender shares in a predetermined percentage of realized appreciation on the subsequent sale of the asset which is the subject of the mortgage. In a particularly preferred embodiment, this mortgage plan can provide the borrower with an interest-free loan, a faster amortization schedule, and a larger, yet more affordable mortgage. The lender also receives substantial benefits, including the potential for a return which exceeds conventional mortgage rate returns, insulation from risk against interest rate fluctuation, and preferred tax treatment in the form of capital gains tax rates paid only upon the subsequent sale of the mortgaged asset. No maturity date need be specified for the mortgage; rather, it may be tied to the ultimate sale of the asset subject to the mortgage.

U.S. Patent Application No. 20070067234 to Beech is directed towards a system and methods are provided for qualifying and selecting mortgage loans for a borrower. The method includes the operation of collecting mortgage loan information from the borrower. A further operation is obtaining credit information for the borrower via a network based on the mortgage loan information. The combined mortgage loan information and credit information can be compared with the conditions of a plurality of mortgage loan programs offered by a mortgage supplier. The comparison can generate a qualified active listing of mortgage loan programs from a plurality of mortgage loan programs.

U.S. Patent Application No. 20050114259 to Almeida discloses a mortgage option method providing a way that applicants wishing to take advantage of low mortgage interest rates, but who, for whatever reason, are unable or unwilling to initiate the application process at the present time, can obtain a right to the low mortgage rate at some time in the future when mortgage rates have increased. Designed for either the residential or commercial real estate market, the method allows customers to lock-in a mortgage at the then current rate for up to four years by paying a nonrefundable up-front premium. The mortgage option may be exercised at any time during the option term, at a rate lower than the prevailing rates.

While there have been a number of mortgage related services, there is a long felt need for mortgage products which alleviate the borrower's need to personally make monthly or bi-weekly payments. Borrowers often like to avoid the stress associated with making monthly mortgage payments.

It is an object of the present invention to provide a system and method by which a mortgage can avoid to avoid making mortgage payments for a predetermined period.

It is a further object of the present invention to provide a system and method where a mortgage can designate funds to be used to pay mortgage or loan payments.

These and other objects, of the present invention will become apparent from the detailed description which follows.

### SUMMARY OF THE INVENTION

In accordance with the invention, a method for creating a moratorium period for a mortgagee comprising the following the steps: creating an equity loan amount to be loaned based upon the value of a mortgagee's property; determining the monthly payment on the loan; determining a period of months which the mortgagee desires to avoid personally making monthly payments; placing a portion of the loan amount equal to the monthly payments for the desired period of months into a fund; and making the monthly payments for the predetermined period from the fund.

In a further embodiment, a method for creating a moratorium period for a mortgagee, comprising the following the steps: creating an equity loan amount to be loaned based upon the value of a mortgagee's property; determining the monthly payment on the loan; determining a period of months which the mortgagee desires to avoid personally making monthly payments; placing a portion of the loan amount equal to the monthly payments for the desired period of months into an escrow fund; placing an amount equal to the real estate taxes and insurance into the escrow fund; and making the monthly loan payments, real estate taxes and insurance for the predetermined period from the fund.

In yet another embodiment, a method for creating a moratorium period for a mortgagee comprising the following the steps: creating an equity loan amount to be loaned based upon the value of a mortgagee's property; determining the monthly payment on the loan; determining a period of months which the mortgagee desires to avoid personally making monthly payments; placing a portion of the loan amount equal to the monthly payments for the desired period of months into a fund; and returning the remainder of the loan to the mortgagee making the monthly payments for the predetermined period from the fund.

### BRIEF DESCRIPTION OF THE FIGURES

FIG. 1 is a diagram of the present invention.

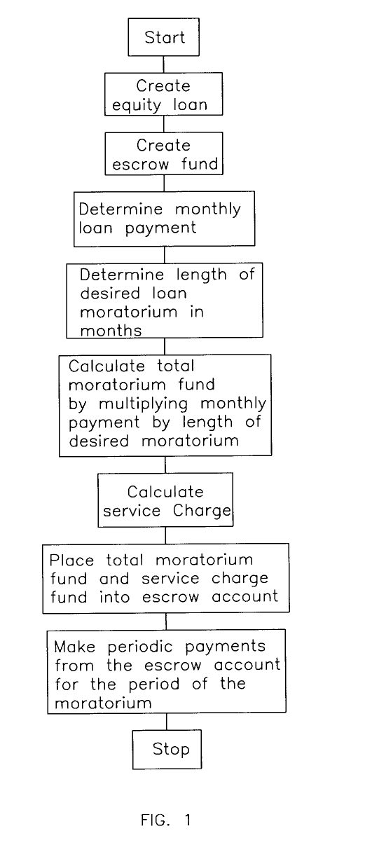

FIG. 2 is an alternative diagram of the invention.

### DESCRIPTION OF THE PREFERRED EMBODIMENT

The invention is described with reference to the enclosed Figures wherein the same numbers are used where applicable. In particular, this invention is directed to a method in which an equity loan is used, in part, to make monthly bimonthly mortgage payments over a preset period of time. This invention is directed to a method for creating a mortgage moratorium.

The present invention is a novel loan payment method wherein the homeowner may, at the time of refinancing a mortgage or purchasing a new home or rental property, to have a third-party mortgage servicer arrange a specialized “payment fund” established from the refinancing equity. By way of the Federal Reserve Systems Automated Clearing House (ACH) network, the fund will automatically forwards the mortgage payments on a bi-weekly or monthly basis on to the mortgage holder.

The operation of the invention is described. A borrower (mortgagee) will take out a second mortgage. The money borrowed will cover the outstanding mortgage, leaving an equity remainder which is divided into the two portions. One portion will go to the mortgagee to use monthly and the second portion will be applied to a moratorium fund.

Initially, the payment under the loan is calculated on a monthly basis plus a small service charge. Depending on the equity set aside at the time of the refinancing, the barrower will be allowed to choose the number of months where he or she themselves will not physically write checks and send monthly payments to the lender or mortgage holder. The number of months the homeowner chooses will be entered into a payment schedule to be paid using a fund, preferably an escrow account. The size of this fund will be dependent of this fund upon the amount of the new mortgage payments to the mortgagor and will factor in a service charge to be paid to a mortgage servicing organization.

The invention is explained by the following example: A hypothetical homeowner wishes to opt for a one year moratorium where he or she will not send a mortgage payment to the lender themselves.

Assume that the homeowner's mortgage refinancing results in an equity loan of $200,000 and a new mortgage payment of $2,661.21. This will make the monthly payments total $31.934.52 for the 12 month moratorium. In accordance with the payment schedule, these payments stored in escrow will be sent in on a bi-weekly/monthly basis resulting in 26/12 payments over the course of the 12 months.

The mortgage servicer will add a service charge (e.g. $3.97) per payment made which equals $103.22 for a full year of payments. This would total an amount of $32,074 to be placed in the escrow fund for the moratorium to commence. This will be withdrawn from the refinancing equity. The homeowner would then receive the difference of $167,962 and have his/her mortgage payments for the next 12 months paid for via a mortgage servicer from the fund.

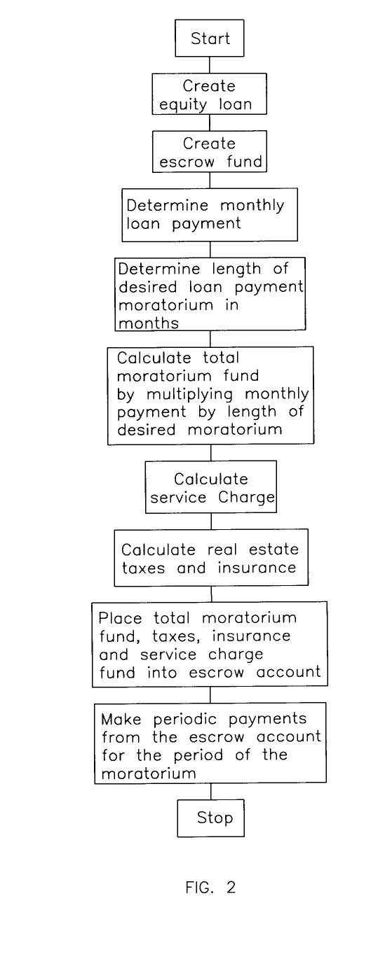

Depending upon the total size of the loan and the size of the monthly payment, the mortgagee can create a multiple year moratorium period. As shown in FIG. 2, the payment scheme can also factor in other variables such as real estate property taxes, homeowner/fire/flood/tornado/earthquake/mudslide insurance and any private mortgage insurance as necessary or required by the mortgage lender.

The invention thus provides a simple method by which a mortgagee can have a moratorium period during which he or she can personally avoid making payments. The present invention has been described with reference to the above discussed preferred embodiment. The true nature and scope of the invention is to be determined with reference to the claims appended hereto.

I claim:

1. A method for creating a moratorium period for a mortgagee, comprising the following the steps:
creating an equity loan amount to be loaned based upon the value of a mortgagee's property;
determining the monthly payment on the loan;
determining a period of months which the mortgagee desires to avoid personally making monthly payments;
placing a portion of the loan amount equal to the monthly payments for the desired period of months into a fund; and
making the monthly payments for the predetermined period from the fund.

2. A method for creating a moratorium period for a mortgagee, comprising the following the steps:
creating an equity loan amount to be loaned based upon the value of a mortgagee's property;
determining the monthly payment on the loan;
determining a period of months which the mortgagee desires to avoid personally making monthly payments;
placing a portion of the loan amount equal to the monthly payments for the desired period of months into an escrow fund;
placing an amount equal to the real estate taxes and insurance into the escrow fund; and
making the monthly loan payments, real estate taxes and insurance for the predetermined period from the fund.

3. A method for creating a moratorium period for a mortgagee, comprising the following the steps:
creating an equity loan amount to be loaned based upon the value of a mortgagee's property;
determining the monthly payment on the loan;
determining a period of months which the mortgagee desires to avoid personally making monthly payments;
placing a portion of the loan amount equal to the monthly payments for the desired period of months into a fund; and
returning the remainder of the loan to the mortgagee
making the monthly payments for the predetermined period from the fund.
